(19) United States
(12) Patent Application Publication
(10) Pub. No.: US 2016/0061095 A1
(43) Pub. Date: Mar. 3, 2016

(54) FUEL INJECTION SYSTEM FOR AN ENGINE

(71) Applicant: Caterpillar Inc., Peoria, IL (US)

(72) Inventors: Andrew J. Loetz, West Lafayette, IN (US); Joel D. Hiltner, Bellingham, WA (US)

(73) Assignee: Caterpillar Inc., Peoria, IL (US)

(21) Appl. No.: 14/934,188

(22) Filed: Nov. 6, 2015

(51) Int. Cl. F02B 19/12; F02D 41/30

(52) U.S. Cl. CPC F02B 19/12; F02D 41/3017

(57) ABSTRACT

A fuel injection system for an engine is described. The fuel injection system includes a prechamber assembly mounted on a cylinder head of the engine. The prechamber assembly includes a prechamber located upstream of a combustion chamber of the engine and configured to receive air-fuel mixture. Further, the prechamber assembly includes a fuel injector to controllably supply fuel into the prechamber, where the supplied fuel mixes with the air-fuel mixture to form a homogeneous mixture of air and fuel at a predefined stoichiometric ratio. The prechamber assembly also includes a spark plug disposed at a downstream region of the prechamber, the downstream region being proximal to the combustion chamber of the engine. The fuel injection system also includes a controller operably coupled to the fuel injector, where the controller is configured to control the predefined stoichiometric ratio of air to fuel in in the prechamber.

### TECHNICAL FIELD

The present disclosure relates to an engine, and more particularly to a fuel injection system for the engine.

### BACKGROUND

In order to improve utilization of fuel, an auxiliary chamber, generally referred to as a pre-combustion chamber or a prechamber, is provided in a cylinder head of an engine. The prechamber is coupled to the cylinder head in a manner, such that the prechamber is in fluid communication with a combustion chamber of the engine. Accordingly, in case of indirect injection, a fuel injector sprays fuel into the prechamber, where the fuel mixes with the air to form the air-fuel mixture. Further, an ignition initiation device, such as a spark plug or a glow plug, is also disposed in the prechamber to initiate the combustion of the air-fuel mixture in the prechamber. As such, the combustion initiates in the prechamber and subsequently proceeds to the combustion chamber. Therefore, volume of the prechamber adds to the volume of the combustion chamber, thereby providing a large volume for the combustion of the air-fuel mixture. However, in order to minimize the amount of particulate matter in exhaust from the engine, it should be ensured that all fuel present in the air-fuel mixture is combusted. Accordingly, the amount of fuel supplied into the prechamber may need to be monitored and controlled.

EP patent application 2362077A2 ('077 application) describes a spark ignited internal combustion engine, hereinafter referred to as the engine. The engine has two fuel pipes connecting a pre-chamber with a source of rich air-fuel mixture or a pure fuel, and a source of lean fuel-air mixture, respectively. The pipes are connected with the pre-chamber by a mixing device for mixing the lean and rich air-fuel mixtures and/or the pure fuel. However, the '077 application does not disclose controlling a stoichiometric ratio of air to fuel in the prechamber.

### SUMMARY OF THE DISCLOSURE

According to an aspect of the present disclosure, a fuel injection system for an engine is described. The fuel injection system includes a prechamber assembly mounted on a cylinder head of the engine. The prechamber assembly includes a prechamber located upstream of a combustion chamber of the engine and configured to receive air-fuel mixture. Further, the prechamber assembly includes a fuel injector to controllably supply fuel into the prechamber, where the supplied fuel mixes with the air-fuel mixture to form a homogeneous mixture of air and fuel at a predefined stoichiometric ratio. The prechamber assembly also includes a spark plug disposed at a downstream region of the prechamber, the downstream region being proximal to the combustion chamber of the engine. The fuel injection system also includes a controller operably coupled to the fuel injector, where the controller is configured to control the predefined stoichiometric ratio of air to fuel in in the prechamber.

Other features and aspects of this disclosure will be apparent from the following description and the accompanying drawings.

### BRIEF DESCRIPTION OF THE DRAWINGS

FIG. 1 illustrates a cross-section of a cylinder head of an engine equipped with a fuel injection system, according to one embodiment of the present disclosure; and

FIG. 2 illustrates an enlarged view of a prechamber assembly of the fuel injection system, according to one embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

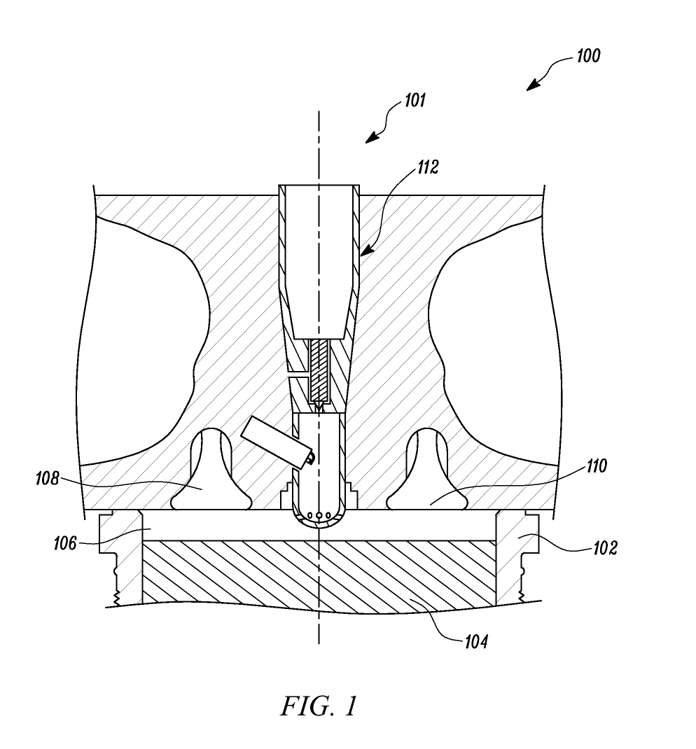

FIG. 1 illustrates a cross-section of a cylinder head 100 of an engine, according to one embodiment of the present disclosure. The engine can embody a compression ignition engine, a spark-ignition engine, or any type of combustion engine known to one skilled in the art. Further, the engine can also be a multi-cylinder engine having an inline configuration, a radial configuration, or other configurations known to one skilled in the art. The engine is used in various applications such as, but not limited to, transportation, for example, in off-highway trucks, in earth-moving machines; or for power generation, for example, when coupled to a generator set; or to drive turbo-machines and/or other equipment such as, pumps, compressors, and other devices known in the art.

The engine includes a cylinder 102 and a piston 104 capable of reciprocating in the cylinder 102. Typically, the piston 104 reciprocates from a bottom dead center (BDC) to a top dead center (TDC) in multiple cycles. The volume between the TDC and the BDC defines a swept volume, where the swept volume is indicative of a volume available for a combusted charge to occupy. The phrase charge herein can be understood either as air or a mixture of air and fuel. As illustrated in FIG. 1, a head portion of the piston 104 is, generally, provided with a concave region. Accordingly, when the piston 104 is at the TDC, volume available between the head portion of the piston 104 and an inner portion of the cylinder head 100, inclusive of the concave portion in the piston 104, functions as a combustion chamber 106.

For the purpose of introducing the charge into the cylinder 102, the cylinder head 100 is equipped with an inlet valve 108. The cylinder head 100 also includes an inlet port (not shown) that cooperates with the inlet valve 108 to allow the charge to be introduced into the cylinder 102. Once the charge is combusted in the combustion chamber 106, the products of the combustion are forced out of the cylinder 102, by the reciprocating movement of the piston 104, with the aid of an exhaust valve 110.

Further, according to an aspect of the present disclosure, the cylinder head 100 is equipped with a fuel injection system 101. Further, the fuel injection system 101 includes a prechamber assembly 112. The prechamber assembly 112 is an auxiliary device that accommodates a secondary chamber, and being provided in the cylinder head 100 to increase the volume of the combustion chamber 106. The combustion chamber 106 is formed as a small and temporary chamber within the cylinder 102.

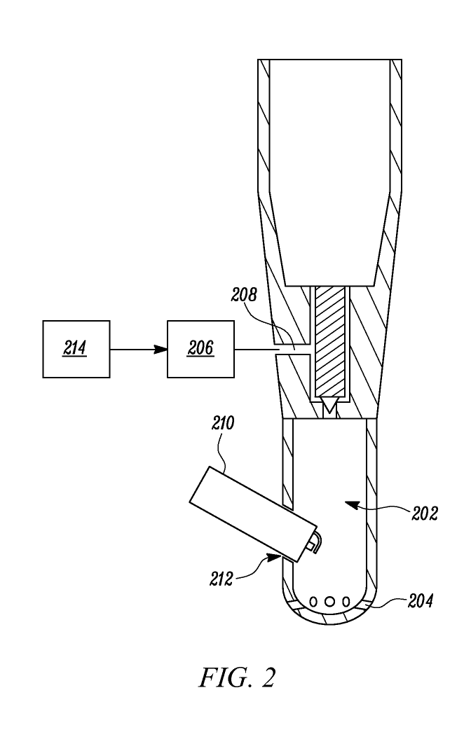

FIG. 2 illustrates an enlarged view of the prechamber assembly 112, in accordance with an embodiment of the present disclosure. In one example, the prechamber assembly 112 may be formed as an inbuilt device with the cylinder head 100. In another example, the prechamber assembly 112 may be a separate device that is configured to fit within the cylinder head 100. It will be appreciated that the prechamber assembly 112 may be mounted on the cylinder head 100 by any other manner known to the person skilled in the art.

The prechamber assembly 112 includes a prechamber 202 located upstream of the combustion chamber 106, where the prechamber 202 receives air-fuel mixture from the combustion chamber 106 during a compression stroke of the piston 104. In an example, the air-fuel mixture occupying the prechamber 202 may be a lean air-fuel mixture. The lean air-fuel mixture is a mixture that includes higher stoichiometric amount of air compared to stoichiometric amount of fuel. Accordingly, a stoichiometric ratio of lean air-fuel mixture would have a value greater than one. For the purpose of receiving the lean air-fuel mixture, multiple ports 204 are provided at a bottom portion of the prechamber 202. In other words, the ports 204 are formed in the wall of the prechamber 202 at a bottom portion of the prechamber assembly 112. During the compression stroke, the piston 104 moves from the BDC to the TDC. Accordingly, the air-fuel mixture drawn into the cylinder 102 in a prior suction stroke is forced into the prechamber 202 through the ports 204, by the piston 104 during the movement from the BDC to the TDC.

Further, the prechamber assembly 112 includes a fuel injector 206 to controllably supply fuel into the prechamber 202. The manner of fuel injection can either be mechanical injection or electronic injection. It will be understood by the person skilled in the art that the fuel injection may be assisted by fuel pump, fuel accumulator, fuel filter, and a fuel distributor, that are not shown in this disclosure. Accordingly, the fuel injector 206 may be coupled to one or more of these devices and, the fuel injector 206 may atomize the fuel and thereafter supply it into the prechamber 202 through a channel 208.

In addition, the prechamber assembly 112 includes a spark plug 210. The spark plug 210 is disposed at a downstream region of the prechamber 202. The phrase downstream region can be understood as the region being proximal to the combustion chamber 106. The wall of the prechamber 202 is provided with a hole 212 for receiving the spark plug 210 therein. The hole 212 includes threads to fasten the spark plug 210 therein. The spark plug 210 is so positioned in the prechamber 202, such that a tip of the spark plug 210 is proximal to the ports 204 provided at the lower region of the prechamber 202.

Further, the fuel injection system 101 includes a controller 214. In one example, the controller 214 may be a processor that includes a single processing unit or a number of units, all of which include multiple computing units. The explicit use of the term ‘processor’ should not be construed to refer exclusively to hardware capable of executing a software application. Rather, in this example, the controller 214 may be implemented as one or more microprocessor, microcomputers, digital signal processor, central processing units, state machine, logic circuitries, and/or any device that is capable of manipulating signals based on operational instructions. Among the capabilities mentioned herein, the controller 214 may also be configured to receive, transmit, and execute computer-readable instructions. In another example, the controller 214 may be an electronic control unit.

The controller 214 is operably coupled to the fuel injector 206 for controlling operation of the fuel injector 206. For instance, the controller 214 is configured to operate the fuel injector 206 for injecting predetermined amount of fuel at appropriate moments during the operation of the engine. As such, the controller 214 is capable of controlling a predefined stoichiometric ratio of air to fuel in the prechamber 202.

Various embodiments disclosed herein are to be taken in the illustrative and explanatory sense, and should in no way be construed as limiting of the present disclosure.

### INDUSTRIAL APPLICABILITY

As described earlier, the prechamber 202 is configured to receive the air-fuel mixture from the combustion chamber 106 during the compression stroke. Due to the compression stroke and owing to a substantially small cross-section of the ports 204, the air-fuel mixture entering the prechamber 202 from the combustion chamber 106 is associated with a substantially high pressure. Moreover, all the air-fuel mixture from the combustion chamber 106 does not enter the prechamber 202 due to the substantially small cross-section of the ports 204. As such, a minimal amount of the air-fuel mixture is forced through the ports 204 due to the movement of the piston 104 from the BDC to the TDC.

In operation, the fuel supplied into the prechamber 202 mixes with the air-fuel mixture to form a homogeneous mixture of air and fuel at a predefined stoichiometric ratio. The homogeneous mixture of air and fuel formed in the prechamber 202 may be a rich air-fuel mixture. The rich air-fuel mixture may be understood as a mixture of air and fuel, where a stoichiometric amount of fuel in the mixture is greater than the stoichiometric amount of air in the mixture. Accordingly, the stoichiometric ratio of rich air-fuel mixture would have a value less than one. For example, based on the control from the controller 214, a stoichiometric ratio of the rich air-fuel mixture in a range of about 0.8 to 0.9 is formed in the prechamber 202. While the fuel entering the prechamber 202 mixes with the air-fuel mixture already present in the prechamber 202, more lean air-fuel mixture enters the prechamber 202 till the end of the compression stroke. The pressure of the additional air-fuel mixture entering the prechamber 202 assists in mixing of the fuel with the air-fuel mixture to form the stoichiometric ratio of the rich air-fuel mixture. As such, a homogeneous rich mixture of air and fuel is formed in the prechamber 202.

A few crank angle degrees before the end of the compression stroke, the spark plug 210 is operated to strike a spark in the prechamber 202 to initiate combustion. As soon as the combustion is initiated, the rich air-fuel mixture in the prechamber 202 is combusted. In particular, the rich air-fuel mixture in the vicinity of the spark plug 210 gets combusted first, followed by the rich air-fuel mixture occupying the peripheral regions of the prechamber 202. However, owing to the small volume of the prechamber 202, all fuel present in the prechamber 202 is combusted. As a result of such combustion, a high pressure is created in the prechamber 202.

In addition, the combustion of the rich air-fuel mixture at the downstream region of the prechamber 202 causes the immediate products of combustion to be exhausted to the combustion chamber 106 through the ports 204. Such immediate products of combustion are associated with high temperature and, therefore, can assist in combustion of the air-fuel mixture present in the combustion chamber 106. Subsequently, due to the increase in pressure in the combustion chamber 106, the piston 104 is forced towards the BDC. As such, the movement of the piston 104 towards the BDC causes all the products of combustion from the prechamber 202 to be drawn into the cylinder 102. Owing to the small volume of the prechamber 202, all the fuel present in the prechamber 202 is combusted, thereby leaving no traces of fuel unburnt in the prechamber 202. In addition, the position of the spark plug 210 at the downstream region of the prechamber 202 aids in combustion of all fuel present in the combustion chamber 106. Therefore, the present subject matter aids in minimizing the amount of pollutants, such as oxides of Nitrogen (NOx), exhausted from the cylinder 102.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A fuel injection system for an engine, the fuel injection system comprising:
a prechamber assembly comprising:
a prechamber located upstream of a combustion chamber of the engine, the prechamber configured to receive air-fuel mixture;
a fuel injector configured to controllably supply fuel into the prechamber, wherein the supplied fuel mixes with the air-fuel mixture to form a homogeneous mixture of air and fuel at a predefined stoichiometric ratio; and
a spark plug disposed at a downstream region of the prechamber, the downstream region being proximal to the combustion chamber of the engine; and
a controller operably coupled to the fuel injector, wherein the controller is configured to control the predefined stoichiometric ratio of air to fuel in the prechamber.
